(19) United States
(12) Patent Application Publication
(10) Pub. No.: US 2026/0038326 A1
(43) Pub. Date: Feb. 5, 2026

(54) SYSTEMS FOR GAMING LOCALIZATION AND MAPPING

(71) Applicant: Chaching App Inc., Reno, NV (US)

(72) Inventors: Jason Amos, Reno, NV (US); John Zink, Reno, NV (US)

(21) Appl. No.: 19/285,169

(22) Filed: Jul. 30, 2025

Related U.S. Application Data
(60) Provisional application No. 63/678,466, filed on Aug. 1, 2024.

(51) Int. Cl. G07F 17/32

(52) U.S. Cl. CPC G07F 17/3206; G07F 17/3258

(57) ABSTRACT

Methods, systems, and devices for localization and mapping of gaming devices and gaming properties are described. A simultaneous localization and mapping (SLAM) system may build or update a map using data from a device while simultaneously locating the device within the map. SLAM systems may be used to provide navigational directions to a mobile device. In the context of gaming properties, data from multiple mobile devices (e.g., user devices such as mobile phones) may be sourced and combined at a cloud application to create a map of a gaming property. The map may identify the physical location of various gaming devices and waypoints within the gaming property. Users of the mobile devices may use a mobile application that interfaces with the cloud application, which may guide (e.g., may provide navigational directions) to a given gaming device within a gaming property.

### CROSS REFERENCE

The present application for patent claims the benefit of U.S. Provisional Patent Application No. 63/678,466 by AMOS et al., entitled “SYSTEMS FOR GAMING LOCALIZATION AND MAPPING,” filed Aug. 1, 2024, assigned to the assignee hereof, and expressly incorporated by reference herein.

### FIELD OF TECHNOLOGY

The present disclosure relates generally to data systems and data processing, and more specifically to systems for gaming localization and mapping.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some examples, a cloud platform may support a mapping and navigation system which may provide navigational directions to a mobile device based on location information of the mobile device. Gaming properties (e.g., casinos) may feature complex layouts and large spaces, which may pose challenges for navigation, asset tracking, security, and operational management within the gaming properties.

### BRIEF DESCRIPTION OF THE DRAWINGS

FIG. 1 illustrates an example of a simultaneous localization and mapping (SLAM) system that supports systems for gaming localization and mapping in accordance with aspects of the present disclosure.

FIG. 2 shows an example of a map that supports systems for gaming localization and mapping in accordance with aspects of the present disclosure.

FIG. 3 shows an example of a map that supports systems for gaming localization and mapping in accordance with aspects of the present disclosure.

FIG. 4 shows an example of a user interface (UI) view that supports systems for gaming localization and mapping in accordance with aspects of the present disclosure.

FIG. 5 shows an example of an augmented reality (AR) UI view that supports systems for gaming localization and mapping in accordance with aspects of the present disclosure.

FIG. 6 shows an example of an AR UI view that supports systems for gaming localization and mapping in accordance with aspects of the present disclosure.

FIG. 7 shows a block diagram of a SLAM system that supports systems for gaming localization and mapping in accordance with aspects of the present disclosure.

FIG. 8 shows a diagram of a system including a device that supports systems for gaming localization and mapping in accordance with aspects of the present disclosure.

FIGS. 9 through 13 show flowcharts illustrating methods that support systems for gaming localization and mapping in accordance with aspects of the present disclosure.

### DETAILED DESCRIPTION

Aspects of this disclosure relate to a simultaneous localization and mapping (SLAM) system designed for use at gaming properties (e.g., casinos). SLAM systems may build or update a map using data from a mobile device while simultaneously locating the mobile device within the map. SLAM systems may be used to provide navigational directions to a mobile device. In the context of gaming properties, data from multiple mobile devices (e.g., user devices such as mobile phones) may be sourced and combined at a cloud application to create a map of a gaming property.

For example, in accordance with aspects of the current disclosure, the map may identify the physical location of various slot machines and waypoints within the gaming property. The mobile devices may interface with the cloud application which may guide (e.g., may provide navigational directions) to a given slot machine within a gaming property. For example, the mobile devices may use a mobile application that interfaces with the cloud application and which may be used to coordinate the display of the mobile devices and to receive input from the users of the mobile devices. While a given mobile device interfaces with the cloud application, the cloud application may collect location data and image data (e.g., photographs and/or video data) as well as other sensor data from the mobile device. The collected location data and image data may be used to create and update the map of the gaming property and to locate the mobile device within the map of the gaming property in order to provide navigational directions to the mobile device. While existing SLAM systems may use visual data (e.g., image capture data such as video data) and/or LIDAR systems and may not integrate other sensors, aspects of the current disclosure involve integrating other sensor data of a mobile device to increase the accuracy and reliability of the mapping and navigation. For example, other sensor data may include the inertial measurement unit (IMU) data (e.g., accelerometer data and gyroscope data), magnetometer, and/or Wi-Fi/Bluetooth signal strength and/or beaconing data to determine the position and velocity of the mobile device, and accordingly the positions of the other objects of interest in the visual data captured by the mobile device with respect to the mobile device.

The cloud application may use crowdsourcing (e.g., may use data from multiple mobile devices that interface with the cloud application) in order to create and update the map of a gaming property. The cloud application may generate maps of multiple gaming properties (e.g., within a city or within a threshold distance), and accordingly the cloud application may provide navigational directions to a user of a mobile device to a selected gaming property from a starting location (e.g., based on global navigation satellite system (GNSS) information). Once within a given gaming property, the navigation may switch to a SLAM based navigational mode. For example, in the SLAM based navigational mode, the mobile device may display navigational directions from the entrance to the gaming property to a selected slot machine based on the stored map of the gaming property at the cloud application and based on the real-time location information for the mobile device. The real-time location information of a mobile device within a gaming property may be gathered from multiple sources, including Wi-Fi or Bluetooth beacons, LIDAR sensors, and/or internal sensor information from the mobile device such as IMU data, compass data, and magnetometer data. In some examples, the SLAM based navigational mode may present augmented reality (AR)-based navigations to the selected destination within the gaming property (e.g., to a selected slot machine).

In some examples, the cloud application may use image processing to identify a type of gaming device (e.g., a type of a slot machine) within a gaming property. For example, the cloud application may use a large language model (LLM) to recognize the art-based text on the slot machines. In some examples, a user of a mobile device may search for slot machines of a given slot machine type using the mobile device, and the mobile device may display navigational directions to a user-selected slot machine provided by the cloud application. In some examples, the cloud application may identify and/or may store progressive jackpot levels for slot machines. For example, the cloud application may identify the progressive jackpot level of a given slot machine based on image data received from a mobile device running the mobile application (e.g., based on text recognition performed by an LLM and/or other technologies). For example, a user of a mobile device running the mobile application that interfaces with the cloud application may input a progressive jackpot level into the mobile application for a given slot machine. In some examples, the mobile application may present the progressive jackpot levels when presenting slots machines to a user. In some examples, a user of the mobile application may filter slot machines via progressive jackpot levels (e.g., the mobile application may present slot machines that satisfy a minimum use-selected progressive jackpot level). Accordingly, users may search for and select slot machines with higher jackpots or which are most likely to hit a jackpot. The cloud application may provide navigational directions from the starting location of the mobile device when the slot machine is selected to the location of the selected slot machine within the gaming property.

Accordingly, the current disclosure provides a SLAM system designed for gaming properties that may incorporate visual data, IMU data, magnetometer data, and Bluetooth/Wi-Fi data to achieve detailed mapping of a gaming property and real-time localization of a mobile device within the gaming property. The SLAM system maybe scalable to accommodate various environments within a casino. The current disclosure may provide for efficient navigation, asset tracking, security management, and operational efficiency. The mobile application may provide a user-friendly interface.

Aspects of the disclosure are initially described in the context of an environment supporting an on-demand database service. Aspects of the disclosure are further illustrated by and described with reference to maps, user interface (UI) views, AR UI views, apparatus diagrams, system diagrams, and flowcharts that relate to systems for gaming localization and mapping.

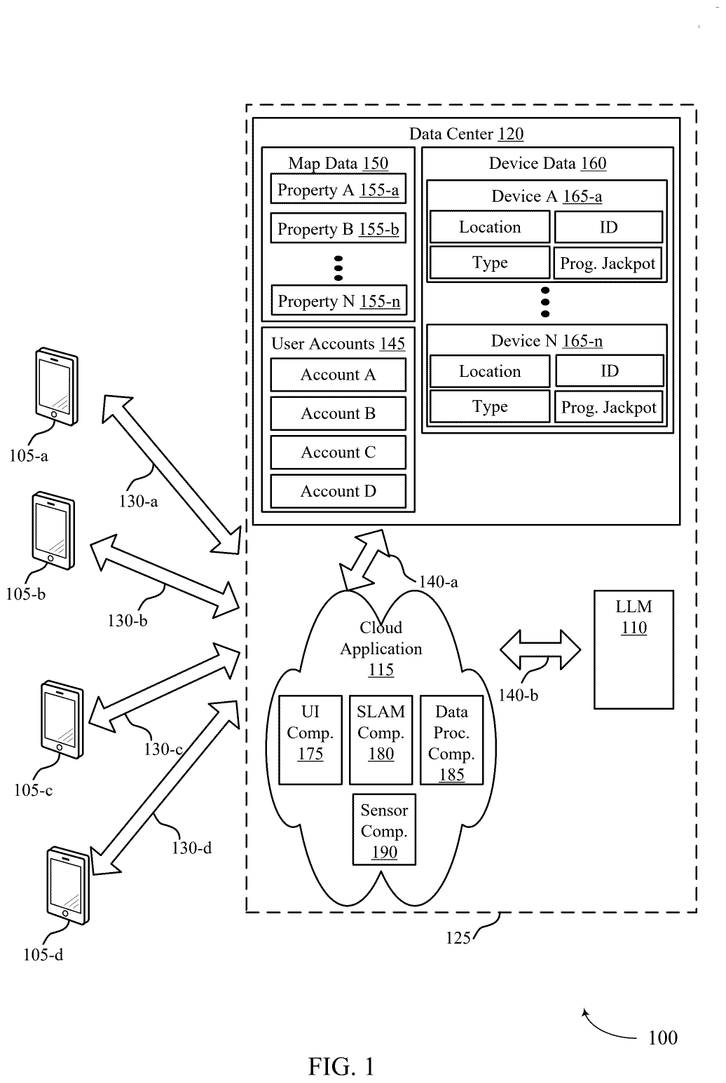

FIG. 1 illustrates an example of a SLAM system 100 that supports gaming localization and mapping in accordance with various aspects of the present disclosure. The system 100 includes mobile devices 105, an LLM 110, a cloud application 115, and a data center 120. The mobile devices 105 may access the cloud application 115 over network connection 130. For example, the cloud application 115 may communicate with the mobile device 105-a via the network connection 130-a, the cloud application 115 may communicate with the mobile device 105-b via the network connection 130-b, the cloud application 115 may communicate with the mobile device 105-c via the network connection 130-c, and the cloud application 115 may communicate with the mobile device 105-d via the network connection 130-d.

The network may implement transfer control protocol and internet protocol (TCP/IP), such as the Internet, or may implement other network protocols. A mobile device 105 may be an example of a user device, such as a smartphone, a tablet computer, a smartwatch, smart glasses, or any other mobile computing device which may communicate over the network connection 130 with the cloud application 115.

The cloud application 115 may be implemented using remote servers. In some cases, the remote servers may be located at one or more data centers 120. The cloud application 115 may offer an on-demand data service to the mobile devices 105. In particular, the cloud application 115 may provide navigation to and within gaming properties (e.g., casinos) to the mobile devices 105. For example, each mobile device 105 may run a corresponding mobile application which may interface with the cloud application 115 and which may display or otherwise provide navigation guidance on a user inter interface of the mobile device 105. In some examples, the mobile application may be a web-based application (e.g., may run in a web browser of the mobile device 105).

In some examples, the cloud application 115 may include multiple components. For example, the cloud application 115 may include a UI component 175 which may provide real-time feedback and visualization of the mapping process and navigational guidance to the mobile devices 105. For example, the UI component 175 may control what is displayed on the UIs of the mobile devices 105 and/or may receive input from the mobile devices 105 (e.g., user selections). The cloud application 115 may also include a SLAM component 180. The SLAM component 180 may integrate visual-inertial data collected from the mobile devices 105 to identify the location of the mobile devices 105, detect objects of interest in visual data collected from the mobile devices 105, detect the location of the objects of interest with respect to the location of the mobile devices 105, and generate map data based on the locations of the objects of interest. The SLAM component 180 may utilize sensor functions such as Kalman filters or other complementary filters to combine the data received from the various sensor sources (e.g., visual data, IMU data, magnetometer data, and Wi-Fi/Bluetooth data). The cloud application 115 may also include a data processing component 185 which may be pipeline which may manage the flow (e.g., continuous flow) of data collected from the sensors of the mobile devices 105 (e.g., visual data, IMU data, magnetometer data, and Wi-Fi/Bluetooth data). The data processing component 185 may provide real-time updates for the poses (positions and orientations) of the mobile devices 105 based on the fused sensor data. The data processing component 185 may pass the pose data to the SLAM component 180, which may use the pose data for navigation and/or mapping. The cloud application 115 may also include a sensor data collection component 190. The sensor data collection component 190 may collect IMU data (e.g., accelerometer and gyroscope data) which may include motion data. The sensor data collection component 190 may estimate the movement and orientation of a mobile device 105 based on the IMU data. The sensor data collection component 190 may collect magnetometer data, which may be magnetic field data which may assist in the estimation of the orientation and heading of the mobile devices 105. The sensor data collection component 190 may collect Wi-Fi and/or Bluetooth data. The Wi-Fi and/or Bluetooth data may include signal strength and/or proximity data (e.g., to a Wi-Fi access point (AP) or a Bluetooth beacon) which may be used to determine the location of the mobile device 105. The sensor data collection component 190 may provide data to the SLAM component 180 (e.g., via the data processing component 185).

The data center 120 may include multiple servers. The multiple servers may be used for data storage, management, and processing. The data center 120 may receive data from the cloud application 115 via a connection 140-a, or directly from the mobile devices 105. In some examples, the data center 120 may utilize multiple redundancies for security purposes. In some examples, the data stored at data center 120 may be backed up by copies of the data at a different data center (not pictured). In some examples, the cloud application 115 may communicate with the LLM 110 via a connection 140-b. The subsystem 125 may include the cloud application 115, the data center 120, and the LLM 110. In some cases, data processing may occur at any of the components of subsystem 125, or at a combination of these components. In some cases, servers may perform the data processing. The servers may be a cloud client or located at data center 120.

Each mobile device 105 may be associated with a user, and each user may have an account with the cloud application 115. For example, the data center 120 may store user account data 145. For example, account A stored in the user account data 145 may be associated with a user of the mobile device 105-a, account B stored in the user account data 145 may be associated with a user of the mobile device 105-b, account C stored in the user account data 145 may be associated with a user of the mobile device 105-c, and account D stored in the user account data 145 may be associated with a user of the mobile device 105-d.

The cloud application 115 may implement a SLAM system as described herein. For example, the cloud application 115 may store include a map data store 150 that may store map data 155 for one or more gaming properties (e.g., map data 155-a for a gaming property A, map data 155-b for a gaming property B, . . . , and map data 155-n for a gaming property N). In some examples, the map data 155 may be provided by management of the gaming properties. In some examples, the cloud application 115 may generate the map data 155 based on sensor data provided by mobile devices 105. In some examples, the map data 155 may be provided by management of the gaming properties and may be updated based on sensor data provided by mobile devices 105.

For example, the mobile devices 105 may upload image data (e.g., pictures and/or real-time video) to the cloud application 115 along with location data that corresponds to the image data. For example, as a user of the mobile device 105-a walks through the gaming property A, the mobile device 105-a may capture video that may be uploaded to the cloud application 115 via the network connection 130 in real-time. The cloud application 115 may identify gaming devices (e.g., slot machines) and other objects of interest (e.g., gaming tables, signs such as exits signs, other direction signs, or advertising signs, restaurants, gift shops, bars, elevators, stairways, etc.) in the image data. Based on the location of the mobile device 105-a at a particular time that an image was captured, as well as other sensor data such as velocity data of the mobile device 105-a, the cloud application 115 may identify the physical location of the gaming devices and other objects of interest. In some examples, the cloud application 115 may perform image processing techniques to identify types of gaming devices and other objects of interest in the image data. For example, the cloud application may provide the image data to the LLM 110 which may identify text graphics on a slot machine to identify the type of slot machine. As another example, the LLM 110 may identify an exit sign in the image data based on text or image recognition. As another example, the LLM 110 may identify elevator bank or stairway in the image data based on text or image recognition. Based on the identified gaming devices and objects of interest in the image data provided from the mobile device 105-a, the cloud application 115 may create a map of the gaming property A. The cloud application 115 may use sensor data (e.g., image data and location data) provided from the mobile devices 105 to generate the map of each gaming property. For example, the cloud application 115 may combine sensor data provided from the mobile device 105-a with sensor data provided from the mobile device 105-b and the mobile device 105-c to generate the map of the gaming property A. The cloud application 115 may similarly crowdsource sensor data from multiple mobile devices 105 to generate and store the map data 155 for other gaming properties (e.g., the map data 155-b for the gaming property B, . . . , the map data 155-n for the gaming property N).

The cloud application 115 may provide navigational directions to the mobile devices 105 to selected target locations within the gaming properties based on the map data 155 for the gaming properties via a mobile application at the mobile devices. For example, the user of the mobile device 105-a may request navigational guidance to a target location within the gaming property A. For example, the target location may be a particular gaming device or other object of interest (e.g., a restaurant, a bar, a gaming table, a gift shop, an ATM). If the mobile device 105-a is located outside of the gaming property A, the cloud application 115 may provide navigational guidance to an entrance of the gaming property A (e.g., based on GNSS data for the mobile device 105-a or cell location data for the mobile device 105-a). For example, the navigational guidance to the entrance of the gaming property A may be provided on a geographic map displayed on a UI of the mobile device 105-a.

Once the mobile device 105-a enters the gaming property A, the navigational guidance may be based on the map data 155-a of the gaming property A stored in the data center 120. In some examples, the navigational guidance within a gaming property may be provided in an AR format. For example, the mobile device 105-a may display a live-feed of a field of view captured by a camera of the mobile device 105 with AR objects (e.g., arrows) overlaid on the live-feed to provide navigational guidance to the selected destination. As another example, in the case where the mobile device 105-a is a pair of smart glasses, the AR objects may be presented on the smart glasses in the field of view of the wearer of the glasses. As the AR objects are displayed based on image data captured by the mobile device 105-a, the image data may be uploaded to the cloud application 115. The cloud application 115 may use the image data to create and/or update the map data 155-a for the gaming property A. Accordingly, the map data may be regularly or continuously updated while users of the mobile devices 105 use the cloud application 115 to provide navigational guidance within the gaming property A.

The cloud application 115 may store device data 165 in a device data store 160 of the data center. For example, as described herein, the cloud application may identify locations of gaming devices (e.g., a gaming device A, . . . , a gaming device N) within gaming properties based on sensor data collected from the mobile devices 105. The device data 165 may include, for each device, a unique identifier (ID), a device type (e.g., a type of slot machine such as by make and model) and location data. For example, the location data may include the gaming property (e.g., the casino) at which the gaming device is located as well as the coordinates at which the gaming device is located within the gaming property. For example, the device data may include device data 165-a for the gaming device A, . . . , and device data 165-n for the gaming device N.

In some examples, the device data 165 may also include progressive jackpot level data for the gaming devices. For example, the cloud application 115 may identify the progressive jackpot level of a given slot machine based on image data received from a mobile device 105. For example, a user of a mobile device 105 may input a progressive jackpot level for a detected slot machine via a UI of the mobile device 105. Accordingly, the cloud application 115 may crowdsource updates to progressive jackpot levels of the gaming devices.

In some examples, a progressive jackpot in a slot machine may be a jackpot that increases as the game is played but the jackpot is not won. When the progressive jackpot is finally hit, the jackpot amount may reset to a predetermined value and begin to increase again as the game is played, but another jackpot is not won. In some cases, the jackpot is increased by a set amount after each play where a jackpot is not won. In some cases, the trigger for advancing the jackpot may be based on a quantity of plays without a jackpot being won (e.g., 1 play, 2 plays, 3 plays etc.), a quantity of time without a jackpot being won, an amount of money wagered at the gaming device without a jackpot being won, other triggers, or any combination thereof. The amount by which the jackpot advances may be set by the owner of the gaming device (e.g., the “house”). In some cases, a small fraction of each bet placed is used to “feed” the jackpot. Thus, the more a gaming device is played, the higher the progressive jackpot for that gaming device.

Different types of progressive jackpot gaming devices may be measured. In some examples, a gaming device may implement an example of a standalone progressive jackpot. For a standalone progressive jackpot, the progressive jackpot is contained within a single gaming device and bets placed on that specific gaming device contribute to the progressive jackpot level. In some examples, a gaming device may implement an example of local progressive jackpot. For a local progressive jackpot, the progressive jackpot may be based on a network of machines within a specific gaming property. Triggers experienced (e.g., games played, bets placed, or time spent playing) by any of the linked gaming devices contribute to a single progressive jackpot. In some examples, a gaming device may implement an example of wide area network progressive jackpot. For a wide area network progressive jackpot, the progressive jackpot may be based on a network of gaming devices that may span multiple gaming properties over a city, state, or even country. Triggers experienced (e.g., games played, bets placed, or time spent playing) by any of the linked gaming devices contribute to a single progressive jackpot.

In some examples, the user may select a gaming device to play from a presented list of gaming devices on the UI of a mobile device 105. For example, the user may filter gaming devices based on locations (e.g., proximity to the location of the mobile device 105, a given gaming property or properties, and/or types of gaming devices). In some examples, the progressive jackpot levels of the gaming devices may also be presented to a user. In some examples, a user of the mobile device 105 may filter slot machines via progressive jackpot levels (e.g., the mobile application may present slot machines that satisfy a minimum use-selected progressive jackpot level). Accordingly, users may search for and select slot machines with higher jackpots or which are most likely to hit a jackpot. As described herein, the cloud application 115 may provide navigational directions to the mobile device 105 (e.g., for display on a UI of the mobile device 105) from the starting location of the mobile device 105 when the slot machine is selected to the location of the selected slot machine within the gaming property.

In some examples, user location data (e.g., locations of the mobile devices 105) may be accessible to managers of the gaming properties. For example, the cloud application 115 may track and store current locations of users in the user account data 145 (e.g., based on the locations of the mobile devices 105 associated with the users). For example, managers of gaming properties may view in the aggregate how many users of the cloud application 115 are within a given area within the gaming property (e.g., in the slots area, in the restaurant, etc.) at a given time or over time. As another example, the location data of the users of the mobile devices 105 may allow security of the gaming properties to quickly respond to incidents (e.g., reduce response times to incidents by providing real-time location information for incidents).

In some examples, the SLAM system may be used for asset tracking for management of gaming properties. For example, as described herein, location data of gaming devices and other objects of interest may constantly be updated by the cloud application 115 and stored in the data center 120 based on sensor data collected from the mobile devices 105 (e.g., based on crowdsourced sensor management). Accordingly, manager of gaming properties may use the SLAM system to track the location of gaming devices and other objects of interest (e.g., furnishings, decorations, equipment such as maintenance equipment) within the gaming property. Thus, the SLAM system may reduce the risk of loss of theft of assets of the gaming property.

In some examples, the SLAM system may be used for scheduling maintenance and operations within the gaming system. For example, the device data 165 may include a maintenance schedule for the gaming devices. Accordingly, the SLAM system may assist maintenance staff of a gaming property by providing navigational guidance to gaming devices and/or other objects within the gaming property. Further, the SLAM system may track when a particular gaming device is due for maintenance. Further, the SLAM system may track if a gaming device is out of order. For example, based on image data, the cloud application 115 may identify if a particular gaming device is out of order, in which case the cloud application 115 may indicate in the device data 165 that the gaming device requires maintenance. In some examples, the cloud application 115 may send an alert to management of the gaming property or maintenance staff of the gaming property when a gaming device is detected to be out of order. In some examples, maintenance staff may send a notification to the cloud application 115 (e.g., via a mobile device 105 of the maintenance staff) once a gaming device is fixed, in which case the device data 165 for the gaming device may be updated to reflect that the gaming device is operational and/or the data and/or time the gaming device was last maintained.

In some examples, the SLAM system may be used for event management within a gaming property. For example, organizing and managing events (e.g., concerts, prize fights, other shows) may demand precise navigation and coordination. The SLAM system may provide detailed maps and real-time positioning to event coordinators of both objects within the gaming property and users/customers of the gaming property, thereby helping the event coordinators manage setup, guest movement, and logistics involved in event management.

In some examples, the SLAM system may be used by users to assist with selection of optimal gaming machine locations. For example, gaming property guests/customers may search for the gaming devices (e.g., slot machines) that will provide the best experience. The cloud application 115 may analyze and suggest locations of slot machines within a gaming property that provide the highest payout rates (e.g., have the highest progressive jackpot levels) or which are in the least crowded area of the gaming property, which may provide a competitive advantage to users of the cloud application. Accordingly, guests of a gaming property may be incentivized to use the cloud application 115 to determine the best gaming devices to use within a gaming property. As the cloud application 115 collects information from the mobile devices 105 that use the cloud application 115, accordingly the more users that use the cloud application 115, more detailed and updated map data may be collected for the gaming property, thereby providing a positive feedback loop.

In some examples, users of the mobile devices 105 may be incentivized to use the cloud application and/or to perform certain tasks via the rewarding of points. For example, users may earn points as they use the application or perform certain tasks (e.g., go to a given location within a gaming property while using the cloud application 115, play a given slot machine etc.) The points may be stored in association with the user account data 145. In some examples, a user may redeem the points to unlock certain features or advantages (e.g., suggestions of optimal gaming locations). In some examples, points may be specific to gaming properties and users may redeem the points for rewards at the specific gaming properties. For example, the points may be redeemed for a free gameplay, discounts or complimentary items at the gift shop, discounts or complementary meals or drinks at restaurants or bars, discounts or complementary tickets to events at the gaming property, discounts or complementary stays at hotels associated with the gaming properties, etc. Accordingly, users may be incentivized to use the cloud application and/or use the cloud application to collect data in desired locations of given gaming properties.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

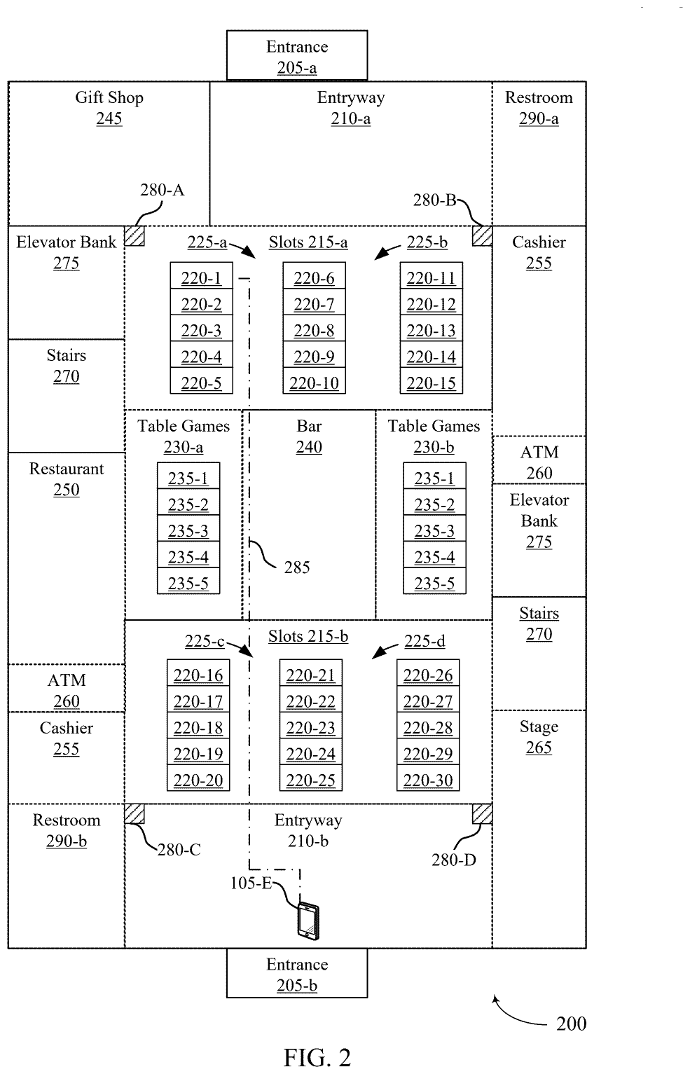

FIG. 2 shows an example of a map 200 that supports systems for gaming localization and mapping in accordance with aspects of the present disclosure. The map 200 may implement or may be implemented by aspects of the system 100. For example, the map 200 may be the map data 155 stored in a map data store 150 of a data center 120 as described herein which may be used to provide navigational directions to a mobile device 105.

The gaming property may include an entrance 205-a and an entrance 205-b. An entryway or lobby 210-a may be adjacent to the entrance 205-a and an entryway or lobby 210-b may be adjacent to the entrance 205-b. A slot machine area 215-a may be adjacent to the entryway or lobby 210-a and a slot machine area 215-b may adjacent to the entryway or lobby 210-a. The slot machine area 215-a may include a set of slot machines 220 (e.g., gaming devices as described herein) and the slot machine area 215-b may include a set of slot machines 220. For example, the slot machine area 215-a may include slot machine 220-1 through slot machine 220-15, and the slot machine area 215-b may include slot machine 220-16 through slot machine 220-30. In some examples, the slot machines 220 may be arranged in rows, and pathways 225 (e.g., a pathway 225-a, a pathway 225-b, a pathway 225-c, and a pathway 225-d) may be arranged between the rows. The gaming property may include a bar 240 and table game areas 230 (e.g., a table games area 230-a and a table games area 230-b). The table game areas 230 may include one or more table games such as blackjack tables, poker tables, roulette tables, craps tables, or any other types of table games.

The gaming property may also include a gift shop 245 or other type of retail store, a restaurant 250, cashier areas 255, one or more automatic teller machines (ATMs) 260, a stage 265, stairways 270, elevator banks 275, and restrooms 290 (e.g., a restroom 290-a and a restroom 290-b).

The map 200 of the gaming property may be generated based on sensor data collected from mobile devices 105 as described with reference to FIG. 1. For example, as users with mobile devices 105 that interface with the cloud application 115 move throughout the gaming property, the cloud application 115 may identify objects of interest within the gaming property and may generate the map based on the location data of the mobile devices 105, visual data provided by the mobile devices, and determined relative locations of the objects of interest with respect to the determined locations of the mobile devices. For example, the location of a mobile device 105 within the gaming property may be based on Wi-Fi or Bluetooth data (e.g., signal strength or proximity data with respect to a Wi-Fi AP or Bluetooth beacon 280 within the gaming property). As another example the location of a mobile device 105 within the gaming property may be based cellular location data (e.g., LTE or 5G location data provided by the mobile devices 105). Additionally or alternatively, the location and velocity of the mobile devices 105 may be determined based on IMU and magnetometer data provided by the mobile devices 105. Such sensor data (e.g., visual data, Wi-Fi/Bluetooth location data, cellular location data, IMU and magnetometer data) may be combined by the cloud application 115 to determine the locations of objects of interest in the gaming property to create the map 200 of the gaming property.

For example, the cloud application 115 may detect objects of interest using image processing techniques (e.g., comparing images to training sets of data to detect objects in the images that correspond to known types of objects). In some examples, the cloud application 115 may provide images to an LLM 110 which may identify objects of interest in images provided from the mobile devices 105. For example, text graphics on slot machine may be used to identify a device type of a slot machine. As another example, signs may be used to identify the entrances (e.g., exit signs may indicate the entrances) in images provided from the mobile devices 105. As another example, signs may be used to identify the various table games 235 and accordingly the table game areas 230, the bar 240, the gift shop 245, the restaurant 250, the cashier area 255, the ATMs 260, the stage 265, the stairways 270, or the elevator banks 275, or any other areas or objects of interest. For example, the cloud application 115 or the LLM 110 may perform text recognition on signs in the images or may identify types of signs (e.g., a restroom sign).

With respect to the slot machines 220, the cloud application 115 may identify and store progressive jackpot levels of the various gaming machines. For example, the cloud application 115 may identify an advertised progressive jackpot level in image data provided of a slot machine 220. As another example, once a slot machine is identified on a mobile device 105 (e.g., a UI of the mobile device), a user of the mobile device 105 may input a progressive jackpot level of the identified slot machine, and the input progressive jackpot level may be stored by the cloud application 115 (e.g., in the device data 165 as described herein).

The map 200 may be used by a user of a mobile device 105 to provide navigation guidance on the UI of the mobile device to a particular object of interest within the gaming property. For example, an object of interest may be a particular slot machine 220, the restaurant 250, the gift shop 245, or any other area or point on the map 200. As described herein, the mobile device 105 may capture image data while providing navigational guidance to a user, and that image data along with other sensor data (e.g., Wi-Fi/Bluetooth data, IMU data, magnetometer data cellular location data) may be used to update the map 200 simultaneously with providing the navigational guidance to the user.

While a user of the mobile device 105 uses the cloud application 115 within the gaming property, the cloud application 115 may provide targeted information to the user of the mobile device 105 (e.g., via the UI of the mobile device 105). For example, the targeted information may be that a progressive jackpot level of a nearby slot machine 220 as the user walks by the slot machine. As another example, the targeted information may be an advertisement (e.g., for the bar 240, the gift shop 245, the restaurant 250, a performance at the stage 265, a performance at a venue associated with the gaming property, or other amenities (e.g., hotel stays, spas, etc.) associated with the gaming property. In some examples, the targeted information (e.g., advertisements) may be based on the current location of the mobile device 105. For example, if the user of a mobile device 105-e enters the gaming property at the entrance 205-b and follows a path 285 to a selected slot machine 220 (e.g., the cloud application 115 may provide navigational guidance to the slot machine 220-1), an advertisement for the restaurant 250 may be displayed on the UI of the mobile device 105-f as the user walks past the restaurant 250 on the way to the slot machine area 215-a.

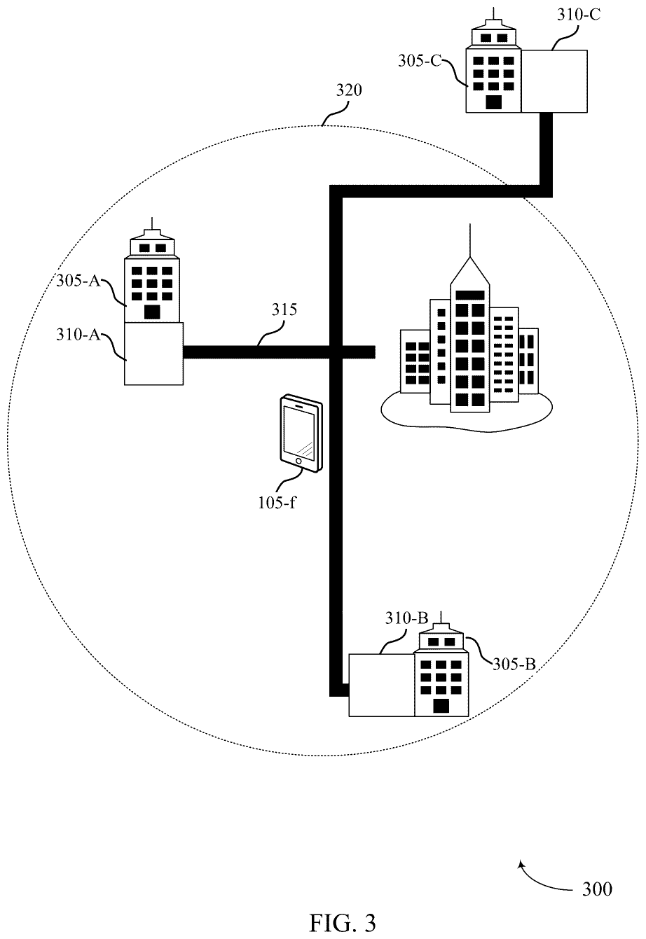

FIG. 3 shows an example of a map 300 that supports systems for gaming localization and mapping in accordance with aspects of the present disclosure. The map 300 may implement or may be implemented by aspects of the system 100. The map 300 may be a geographic map and may be used to provide navigational guidance from a starting point of a mobile device 105-f to a selected gaming property 305 (e.g., based on a selected gaming device located within the selected gaming property).

In some examples, when the mobile device 105-f is located outside of a gaming property 305, the user of the mobile device 105-f may browse or search for gaming devices within a threshold proximity 320 of the mobile device 105-f using the cloud application 115. For example, the gaming property 305-a and the gaming property 305-b may be located within the threshold proximity 320, but the gaming property 305-b may be located outside of the threshold proximity 320. The cloud application 115 may cause display of gaming devices that satisfy user selected filters (e.g., based on gaming device types or progressive jackpot levels). Once the user selects a gaming device or gaming property, the cloud application 115 may provide navigational guidance to the mobile device 105-f from the starting location of the mobile device 105-f to the selected gaming property 305 (e.g., or the gaming property 305 which includes the selected gaming device). For example, if the gaming property 305-a is the selected gaming property, the cloud application 115 may provide navigational guidance along roadways 315 from the starting location of the mobile device 105-f to a parking lot 310-a of the gaming property 305-a. Similarly, the gaming property 305-b may have an associated parking lot 310-b and the gaming property 305-c may have an associated parking lot 310-c. The cloud application 115 may provide navigational guidance from the parking lot 310-a to the entrance of the gaming property 305-a. The navigational guidance may be based on the map 300 and GNSS and/or cellular location data for the mobile device 105-f.

Once the mobile device 105-f enters the gaming property 305-a, the cloud application 115 may provide navigational guidance to the mobile device 105-f based on the stored map of the gaming property 305-a, for example, as described with reference to FIG. 2.

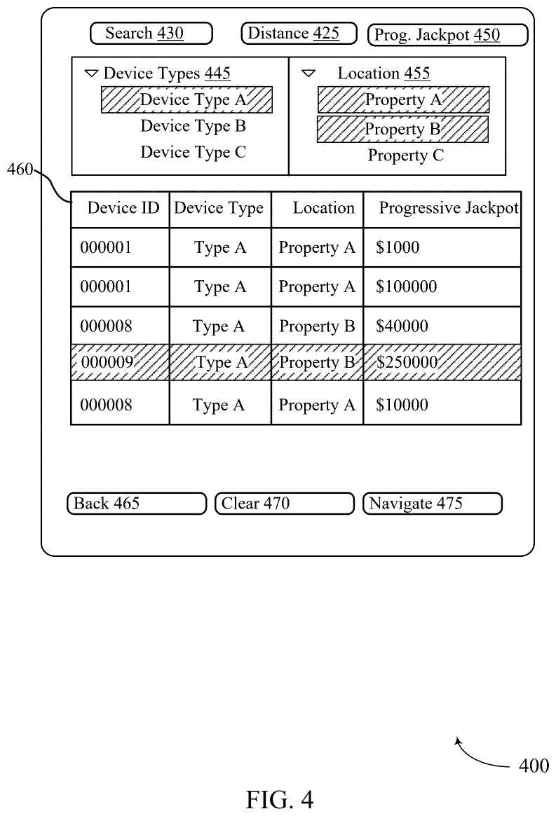

FIG. 4 shows an example of a UI view 400 that supports systems for gaming localization and mapping in accordance with aspects of the present disclosure. The UI view 400 may implement or may be implemented by aspects of the system 100, the map 200, or the map 300 as described herein. For example, the UI view 400 may show a view of a UI of a mobile device 105 that interfaces with the cloud application 115 as described with reference to FIG. 1.

As described herein, a user of a mobile device 105 may browse or search for gaming devices (e.g., within a threshold proximity of the current location of the mobile device 105). For example, a distance field 425 may enable the user to specify the threshold distance. In some examples, the distance field may instead filter by city, zip code, or other geographic region. A search field 430 may enable the user to search for a specific gaming property or a specific gaming device type.

A device type dropdown field 445 may enable the user to browse for and select gaming devices within the threshold proximity/city/geographic region specified by the user. For example, as shown in the UI view 400, the user may have selected the device Type A from a selectable set of device types include the device Type A, the device Type B, and the device Type C. The location dropdown field 455 may enable the user to browse for and select gaming properties (e.g., casinos) within the threshold proximity/city/geographic region specified by the user. For example, as shown in the UI view 400, the user may have selected the gaming property A and the gaming property B from a selectable set of gaming devices within the threshold proximity/city/geographic region specified by the user.

The listing of devices 460 may list gaming devices that satisfy the filters selected by the user. For example, the listing of devices may include devices that have the selected device Type A and are located in either the selected gaming property A or the selected gaming property B. The listing of devices may include information such as the device ID, the type of device (e.g., device Type A), the location of the gaming device (e.g., the gaming property), and the progressive jackpot level. In some examples, the UI view 400 may include a progressive jackpot field 450 to specify a minimum progressive jackpot level. In some examples, the listing of devices 460 may be filtered or re-orderable based on the device type, the location, or the progressive jackpot level (e.g., based on selecting the top of the corresponding column).

In some examples, the UI view 400 may include a back field 465 to undo the most recent selection or filter. In some examples, the UI view 400 may include a clear field 470 to undo all selections and filters. In some examples, the UI view 400 may include a navigate field 475. For example, when the user selects a particular gaming device (e.g., the device with ID 000009 as shown in FIG. 4), and the user selects the navigate field, the cloud application 115 may provide navigational guidance to the selected gaming device from the starting location of the mobile application as described herein.

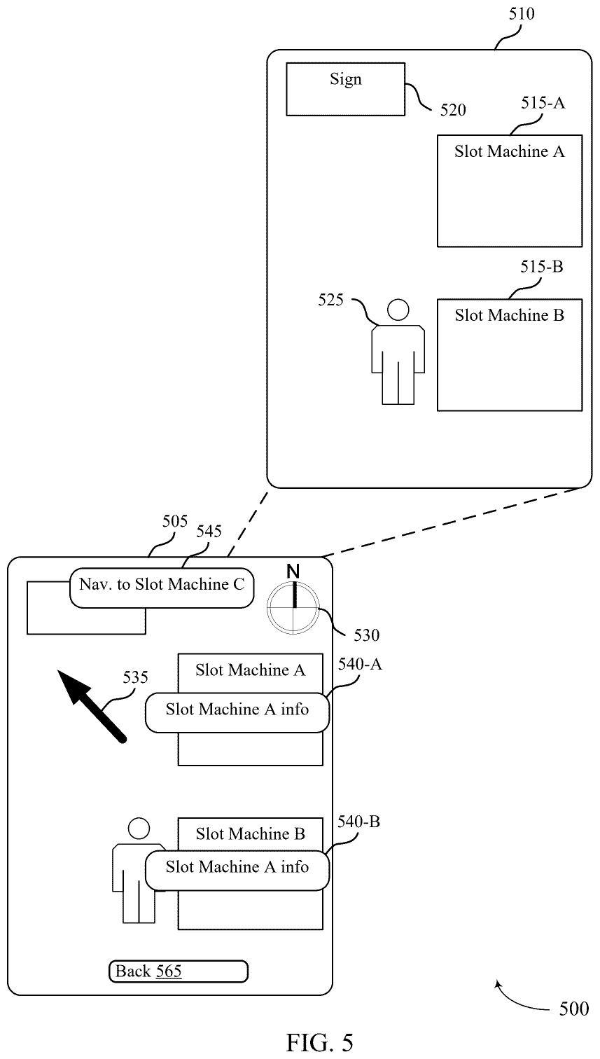

FIG. 5 shows an example 500 of an AR UI view 505 that supports systems for gaming localization and mapping in accordance with aspects of the present disclosure. The AR UI view 505 may implement or may be implemented by aspects of the system 100, the map 200, or the map 300 as described herein. For example, the AR UI view 505 may show a view of a UI of a mobile device 105 while providing navigational guidance via the AR UI view 505 within a gaming property based on the stored map of the gaming property.

An image capture component (e.g., a camera) of the mobile device 105 may capture an image of a field of view 510 of the image capture component. The AR UI view 505 may display the captured image of the field of view 510. The AR UI view 505 may overlay one or more AR objects (e.g., a compass object 530, navigation objects 535, and/or information objects) over the image of the field of view 510. For example, a slot machine A 515-a, a slot machine B 515-b, a sign 520 (e.g., some type of notice giving information to others such as banners, billboards, physical advertisements, and/or pictograms), and person 525 may be within the image of the field of view 510 of the image capture component.

The cloud application 115 may be providing navigational guidance to a selected slot machine (e.g., slot machine C). The AR UI view 505 may display an AR object 545 that indicates the cloud application 115 is providing navigational guidance to the slot machine C. The AR UI view 505 may also include a navigation object 535 overlaid on the image of the field of view that provides navigational guidance to the selected slot machine C (e.g., an arrow that points to the location of the slot machine C). The cloud application 115 may also provide informational AR objects 540 based on the location of the mobile device within the gaming property and/or identified objects within the field of view 510. For example, the cloud application 115 may identify the slot machine A 515-a and the slot machine B 515-b and may provide information regarding the identified slot machine A 515-a and slot machine B 515-b via the information AR object 540-a and the information AR object 540-b, respectively. For example, the information AR object 540-a and the information AR object 540-b may provide details regarding the slot machine A 515-a and the slot machine B 515-b such as the type of slot machines and/or the progressive jackpot levels. The AR UI view 505 may include a back object 565 to exit the navigational display mode.

In some examples, the AR UI view 505 may present reward information for the user of the mobile device 105 to earn points (e.g., which may be stored in association with user account data 145 as described herein) and may be redeemed for rewards as described herein. For example, the user may earn points by playing a specific slot machine. For example, the information AR object 540-a and the information AR object 540-b may indicate points available to earn for playing the slot machine A 515-a and/or the slot machine B 515-b. As another example, the AR object 545 may indicate the points available to earn for completing the navigation to the slot machine C.

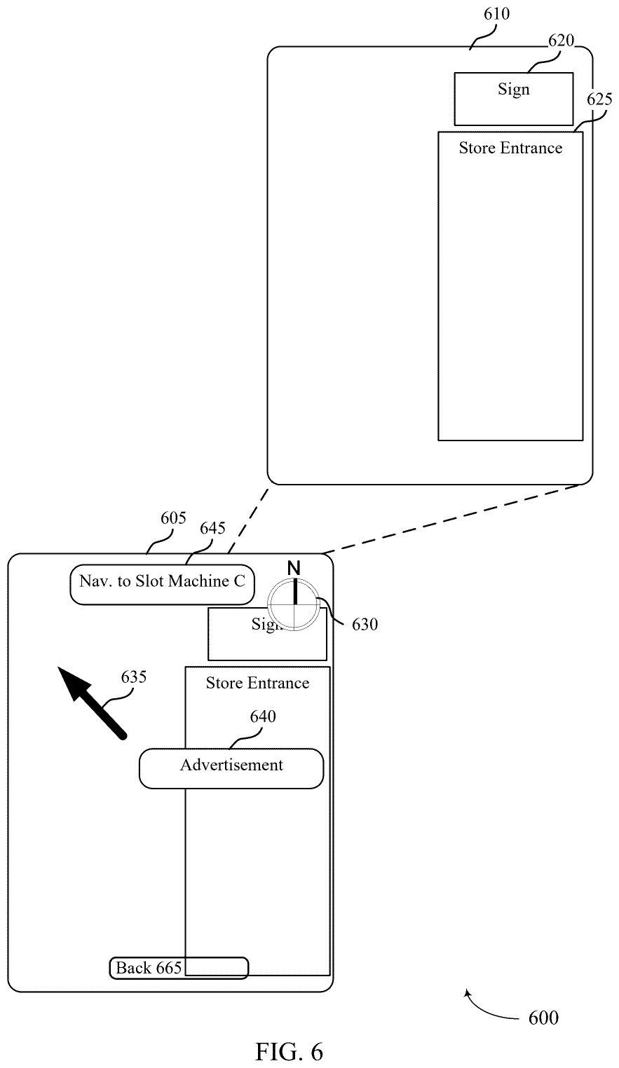

FIG. 6 shows an example 600 of an AR UI view 605 that supports systems for gaming localization and mapping in accordance with aspects of the present disclosure. The AR UI view 605 may implement or may be implemented by aspects of the system 100, the map 200, or the map 300 as described herein. For example, the AR UI view 605 may show a view of a UI of a mobile device 105 while providing navigational guidance via the AR UI view 605 within a gaming property based on the stored map of the gaming property.

An image capture component (e.g., a camera) of the mobile device 105 may capture an image of a field of view 610 of the image capture component. The AR UI view 605 may display the captured image of the field of view 610. The AR UI view 605 may overlay one or more AR objects (e.g., a compass object 630, navigation objects 635, and/or informational AR objects 640) over the image of the field of view 610. For example, a sign 620, and an entrance to a store 625 may be within the image of the field of view 610 of the image capture component.

The cloud application 115 may be providing navigational guidance to a selected slot machine (e.g., slot machine C). The AR UI view 605 may display an AR object 645 that indicates the cloud application 115 is providing navigational guidance to the slot machine C. The AR UI view 605 may also include a navigation object 635 overlaid on the image of the field of view that provides navigational guidance to the selected slot machine C (e.g., an arrow that points to the location of the slot machine C). The cloud application 115 may also provide informational AR objects 640 based on the location of the mobile device 105 within the gaming property and/or identified objects within the field of view 610. For example, the cloud application 115 may identify the store 625 (e.g., based on the sign 620 which may advertise the store 625) and may provide information via the informational AR object 640 regarding the identified store, for example an advertisement. The AR UI view 605 may include a back object 665 to exit the navigational display mode.

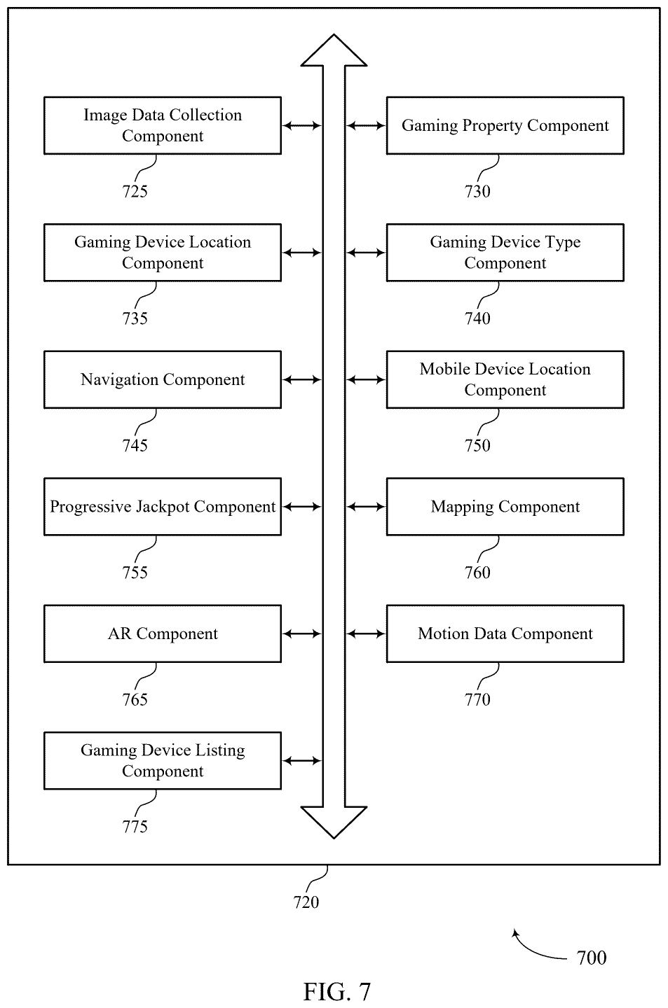

FIG. 7 shows a block diagram 700 of a SLAM system 720 that supports systems for gaming localization and mapping in accordance with aspects of the present disclosure. The SLAM system 720 may be an example of aspects of a cloud application 115 as described with reference to FIGS. 1 through 6. The SLAM system 720, or various components thereof, may be an example of means for performing various aspects of systems for gaming localization and mapping as described herein. For example, the SLAM system 720 may include an image data collection component 725, a gaming property component 730, a gaming device location component 735, a gaming device type component 740, a navigation component 745, a mobile device location component 750, a progressive jackpot component 755, a mapping component 760, an AR component 765, a motion data component 770, a gaming device listing component 775, or any combination thereof. Each of these components, or components of subcomponents thereof (e.g., one or more processors, one or more memories), may communicate, directly or indirectly, with one another (e.g., via one or more buses).

The image data collection component 725 may be configured to support receiving, from a first mobile device, image data and location data associated with the image data. The gaming property component 730 may be configured to support identifying, by the system, a property associated with the location data. The gaming device location component 735 may be configured to support identifying, by the system, a physical location of a gaming device within the property based on the image data and the location data. The gaming device type component 740 may be configured to support identifying, by the system, a gaming device type of the gaming device. In some examples, the gaming device location component 735 may be configured to support storing, in a data store accessible to the system, an identifier of the gaming device in association with the physical location of the gaming device within the property and the gaming device type.

In some examples, the progressive jackpot component 755 may be configured to support identifying, based on the image data, a progressive jackpot parameter associated with the gaming device. In some examples, the progressive jackpot component 755 may be configured to support storing, in the data store, the progressive jackpot parameter in association with the identifier of the gaming device.

In some examples, the progressive jackpot component 755 may be configured to support receiving, from the first mobile device, an indication of a progressive jackpot parameter associated with the gaming device. In some examples, the progressive jackpot component 755 may be configured to support storing, in the data store, the progressive jackpot parameter in association with the identifier of the gaming device.

In some examples, the gaming device location component 735 may be configured to support identifying, by the system and based on the image data and the location data, a second physical location of a second gaming device. In some examples, the gaming device location component 735 may be configured to support identifying, by the system, a second identifier associated with the second gaming device stored in the data store based on the second physical location. In some examples, the progressive jackpot component 755 may be configured to support updating a progressive jackpot parameter in the data store associated with the second identifier based on the image data or an indication of the progressive jackpot parameter received from the first mobile device.

In some examples, the mapping component 760 may be configured to support identifying, based on the image data and the location data, one or more waypoints within the property. In some examples, the mapping component 760 may be configured to support storing, in the data store, one or more respective identifiers for the one or more waypoints in association with one or more respective identified physical locations of the one or more waypoints.

In some examples, the one or more waypoints include an entrance to the property, a restroom, a restaurant, a retail store, a physical sign, an automatic teller machine, an elevator bank, a stairway, a bar, a ticket window, or a combination thereof.

In some examples, the mapping component 760 may be configured to support creating a map of the property based on the one or more respective identified physical locations of the one or more waypoints and the physical location of the gaming device.

In some examples, the navigation component 745 may be configured to support receiving, from a second mobile device, a request for directions to the gaming device. In some examples, the navigation component 745 may be configured to support outputting real-time directions to the gaming device to the second mobile device based on the map of the property and second location data of the second mobile device.

In some examples, the mapping component 760 may be configured to support updating a map of the property based on the identified one or more waypoints and the identified gaming device. In some examples, the navigation component 745 may be configured to support outputting, to the first mobile device in parallel with updating the map, real-time directions to a second gaming device in the property based on the map and the location data of the first mobile device.

In some examples, the motion data component 770 may be configured to support receiving real-time motion data from the first mobile device to determine a real-time location of the first mobile device within the map in accordance with a simultaneous location and mapping scheme, where the real-time directions are based on the real-time location.

In some examples, the real-time motion data includes accelerometer data, gyroscope data, or magnetometer data.

In some examples, the gaming device location component 735 may be configured to support identifying, by the system, a second physical location of a second gaming device within the property based on the image data and the location data. In some examples, the gaming device type component 740 may be configured to support identifying, by the system, a second gaming device type of the second gaming device. In some examples, the gaming device location component 735 may be configured to support storing, in the data store, a second identifier of the second gaming device in association with the second physical location of the gaming device within the property and in association with the second gaming device type.

In some examples, the gaming device location component 735 may be configured to support identifying, by the system, a second physical location of a second gaming device within the property based on the image data and the location data. In some examples, the gaming device type component 740 may be configured to support identifying, by the system, that the second gaming device is the gaming device type. In some examples, the gaming device location component 735 may be configured to support storing, in the data store, a second identifier of the second gaming device in association with the second physical location of the gaming device within the property and in association with the gaming device type.

In some examples, the image data collection component 725 may be configured to support receiving, from the first mobile device or a second mobile device, second image data and second location data associated with the second image data. In some examples, the gaming property component 730 may be configured to support identifying, by the system, a second property associated with the second location data. In some examples, the gaming device location component 735 may be configured to support identifying, by the system, a second physical location of a second gaming device within the second property based on the second image data and the second location data. In some examples, the gaming device type component 740 may be configured to support identifying, by the system, a second gaming device type of the second gaming device. In some examples, the gaming device location component 735 may be configured to support storing, in the data store, a second identifier of the second gaming device in association with the second physical location of the second gaming device within the second property and in association with the second gaming device type.

In some examples, the image data collection component 725 may be configured to support receiving, from the first mobile device or a second mobile device, second image data and second location data associated with the second image data. In some examples, the gaming property component 730 may be configured to support identifying, by the system, a second property associated with the second location data. In some examples, the gaming device location component 735 may be configured to support identifying, by the system, a second physical location of a second gaming device within the second property based on the second image data and the second location data. In some examples, the gaming device type component 740 may be configured to support identifying, by the system, that the second gaming device has the gaming device type. In some examples, the gaming device location component 735 may be configured to support storing, in the data store, a second identifier of the second gaming device in association with the second physical location of the second gaming device within the second property and in association with the gaming device type.

In some examples, to support identifying the physical location of the gaming device, the gaming device location component 735 may be configured to support identifying the physical location of the gaming device with respect to a second physical location of the first mobile device at a time the image data is captured, where the location data corresponds to the second physical location of the first mobile device at the time the image data is captured.

In some examples, to support receiving the location data, the gaming device location component 735 may be configured to support receiving the location data based on a Wi-Fi connection or a Bluetooth connection of the first mobile device within the property.

In some examples, to support identifying the gaming device type, the gaming device type component 740 may be configured to support comparing an image of the gaming device from the image data to a set of images corresponding to a set of gaming device types, where the set of gaming device types include the gaming device type, and where the gaming device is identified as having the gaming device type based on the image of the gaming device satisfying a similarity threshold with a respective image of the gaming device type.

In some examples, to support identifying the gaming device type, the gaming device type component 740 may be configured to support receiving, from the first mobile device, an indication of the gaming device type.

In some examples, the gaming device type component 740 may be configured to support outputting a gaming device type input window to the first mobile device based on identifying the gaming device within the image data, where receiving the indication of the gaming device includes receiving an input of the gaming device type via the gaming device type input window.

In some examples, to support identifying the property, the gaming property component 730 may be configured to support comparing the location data to a set of stored locations of a set of properties. In some examples, to support identifying the property, the gaming property component 730 may be configured to support identifying the property based on the location data matching a stored location of the set of properties.

The navigation component 745 may be configured to support receiving, from a first mobile device, a request for real-time directions from a starting location of the first mobile device to a gaming device within a property. The mobile device location component 750 may be configured to support receiving, from the first mobile device, real-time location data and real-time image data from the first mobile device. In some examples, the navigation component 745 may be configured to support outputting, to the first mobile device, the real-time directions from the starting location to the gaming device based on the real-time location data, the real-time image data, and a map of the property stored in a data store accessible to the system, where the map includes a first set of respective physical locations of a set of waypoints and a second set of respective physical locations of a set of gaming devices within the property, the set of gaming devices including the gaming device.

In some examples, to support causing presentation of the real-time directions, the AR component 765 may be configured to support causing display of the real-time directions overlaid on a real-time video feed captured by the first mobile device, where the real-time image data includes the real-time video feed.

In some examples, the real-time directions include one or more augmented objects overlaid on the real-time video feed.

In some examples, causing presentation of the real-time directions is based on identifying at least one way point of the set of waypoints or at least one gaming device of the set of gaming devices.

In some examples, the progressive jackpot component 755 may be configured to support identifying, based on the real-time image data, a progressive jackpot parameter of a second gaming device of the set of gaming devices. In some examples, the progressive jackpot component 755 may be configured to support updating the progressive jackpot parameter associated with an identifier for the second gaming device in the data store based on identifying the progressive jackpot parameter.

In some examples, the motion data component 770 may be configured to support receiving real-time motion data from the first mobile device to determine a real-time location of the first mobile device within the map in accordance with a simultaneous location and mapping scheme, where the real-time directions are based on the real-time location.

In some examples, the real-time motion data includes accelerometer data, gyroscope data, or magnetometer data.

In some examples, the real-time location data is based on a Wi-Fi connection or a Bluetooth connection of the first mobile device within the property.

In some examples, the gaming device listing component 775 may be configured to support receiving, from the first mobile device, a second request for a listing of gaming devices of a gaming device type. In some examples, the gaming device listing component 775 may be configured to support outputting, to the first mobile device and based on the second request, the listing of gaming devices and respective locations of gaming devices of the listing of gaming devices, the listing of gaming devices including the gaming device. In some examples, the navigation component 745 may be configured to support receiving, from the first mobile device, a selection of the gaming device, where receiving the request for the real-time directions is based on receiving the selection.

In some examples, causing presentation of the respective locations of the gaming devices includes causing presentation of respective properties at which each of the gaming devices are located.

In some examples, the progressive jackpot component 755 may be configured to support outputting, to the first mobile device, respective progressive jackpot parameters associated with each of the gaming devices.

In some examples, the gaming device listing component 775 may be configured to support receiving, from the first mobile device, a second request for a listing of gaming devices that satisfy a progressive jackpot parameter threshold. In some examples, the gaming device listing component 775 may be configured to support outputting, to the first mobile device and based on the second request, the listing of gaming devices and respective locations of gaming devices of the listing of gaming devices, the listing of gaming devices including the gaming device. In some examples, the navigation component 745 may be configured to support receiving, from the first mobile device, a selection of the gaming device, where receiving the request for the real-time directions is based on receiving the selection.

In some examples, the AR component 765 may be configured to support outputting, to the first mobile device and based on the real-time location data, an advertisement associated with the property.

In some examples, the set of waypoints include an entrance to the property, a restroom, a restaurant, a retail store, a physical sign, an automatic teller machine, an elevator bank, a stairway, a bar, a ticket window, or a combination thereof.

In some examples, the navigation component 745 may be configured to support causing output, by the first mobile device, of audio cues in association with the outputting of the real-time directions.

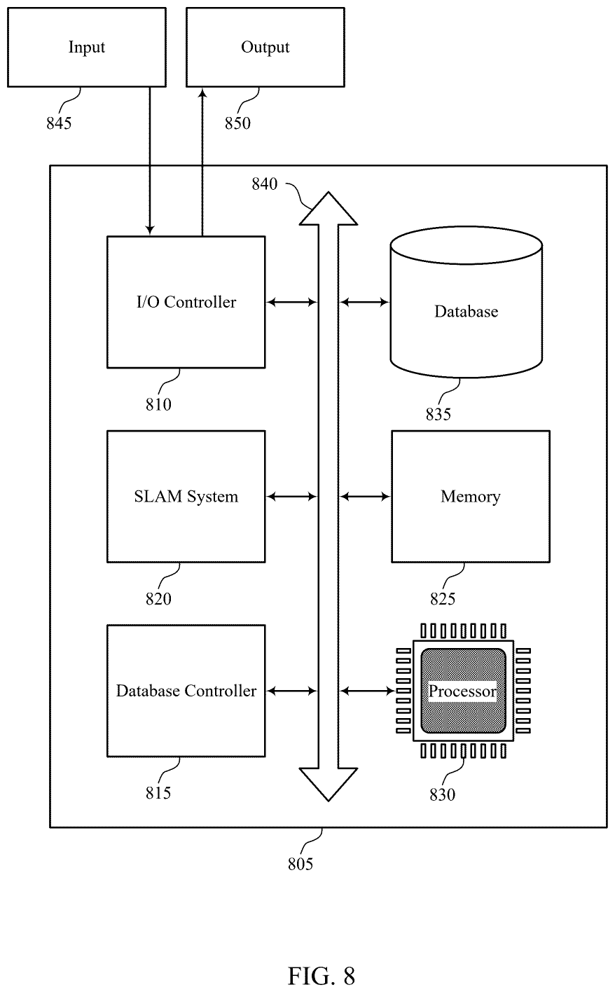

FIG. 8 shows a diagram of a system 805 that supports systems for gaming localization and mapping in accordance with aspects of the present disclosure. The system 805 may include components for bi-directional data communications including components for transmitting and receiving communications, such as SLAM system 820, an input/output (I/O) controller, such as an I/O controller 810, a database controller 815, at least one memory 825, at least one processor 830, and a database 835. The SLAM system 820 may be an example of a cloud application 115 or a SLAM system 720 as described herein. In some examples, one or more of these components may be in electronic communication or otherwise coupled (e.g., operatively, communicatively, functionally, electronically, electrically) via one or more buses (e.g., a bus 840). In some examples, one or more components of the system 805 may be implemented across one or more distributed servers or as cloud applications and may communicate with each other over network connections (e.g., network connections 130 or 140 as described herein). For example, the database 835 may be an example of the data center 120 as described herein and the SLAM system 820 may be an example of the cloud application 115 as described herein, and the SLAM system 820 may communicate with the database 835 via a connection 140-a as described herein.

The I/O controller 810 may manage input signals 845 and output signals 850 for the system 805. The I/O controller 810 may also manage peripherals not integrated into the system 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the system 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the system 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting systems for gaming localization and mapping). The processor 830 may be an example of a single processor or multiple processors. For example, the system 805 may include one or more processors 830.

For example, the SLAM system 820 may be configured to support receiving, from a first mobile device, image data and location data associated with the image data. The SLAM system 820 may be configured to support identifying, by the system, a property associated with the location data. The SLAM system 820 may be configured to support identifying, by the system, a physical location of a gaming device within the property based on the image data and the location data. The SLAM system 820 may be configured to support identifying, by the system, a gaming device type of the gaming device. The SLAM system 820 may be configured to support storing, in a data store accessible to the system, an identifier of the gaming device in association with the physical location of the gaming device within the property and the gaming device type.

For example, the SLAM system 820 may be configured to support receiving, from a first mobile device, a request for real-time directions from a starting location of the first mobile device to a gaming device within a property. The SLAM system 820 may be configured to support receiving, from the first mobile device, real-time location data and real-time image data from the first mobile device. The SLAM system 820 may be configured to support outputting, to the first mobile device, the real-time directions from the starting location to the gaming device based on the real-time location data, the real-time image data, and a map of the property stored in a data store accessible to the system, where the map includes a first set of respective physical locations of a set of waypoints and a second set of respective physical locations of a set of gaming devices within the property, the set of gaming devices including the gaming device.

By including or configuring the SLAM system 820 in accordance with examples as described herein, the system 805 may support techniques for efficient mapping of gaming properties and localization of mobile devices within gaming properties in order to provide navigation to the mobile devices within the gaming properties.

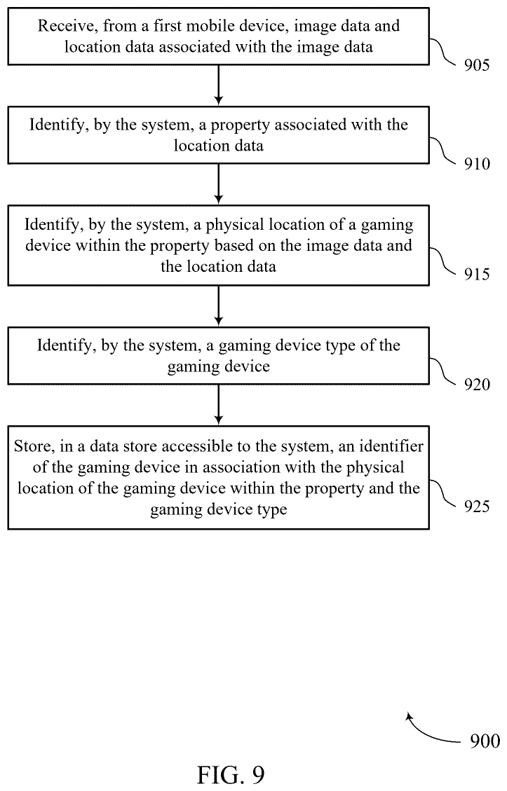

FIG. 9 shows a flowchart illustrating a method 900 that supports systems for gaming localization and mapping in accordance with aspects of the present disclosure. The operations of the method 900 may be implemented by a SLAM system or its components as described herein. For example, the operations of the method 900 may be performed by a SLAM system as described with reference to FIGS. 1 through 8. In some examples, a SLAM system may execute a set of instructions to control the functional elements of the SLAM system to perform the described functions. Additionally, or alternatively, the SLAM system may perform aspects of the described functions using special-purpose hardware.

At 905, the method may include receiving, from a first mobile device, image data and location data associated with the image data. The operations of 905 may be performed in accordance with examples as disclosed herein. In some examples, aspects of the operations of 905 may be performed by an image data collection component 725 as described with reference to FIG. 7.

At 910, the method may include identifying, by the system, a property associated with the location data. The operations of 910 may be performed in accordance with examples as disclosed herein. In some examples, aspects of the operations of 910 may be performed by a gaming property component 730 as described with reference to FIG. 7.

At 915, the method may include identifying, by the system, a physical location of a gaming device within the property based on the image data and the location data. The operations of 915 may be performed in accordance with examples as disclosed herein. In some examples, aspects of the operations of 915 may be performed by a gaming device location component 735 as described with reference to FIG. 7.

At 920, the method may include identifying, by the system, a gaming device type of the gaming device. The operations of 920 may be performed in accordance with examples as disclosed herein. In some examples, aspects of the operations of 920 may be performed by a gaming device type component 740 as described with reference to FIG. 7.

At 925, the method may include storing, in a data store accessible to the system, an identifier of the gaming device in association with the physical location of the gaming device within the property and the gaming device type. The operations of 925 may be performed in accordance with examples as disclosed herein. In some examples, aspects of the operations of 925 may be performed by a gaming device location component 735 as described with reference to FIG. 7.

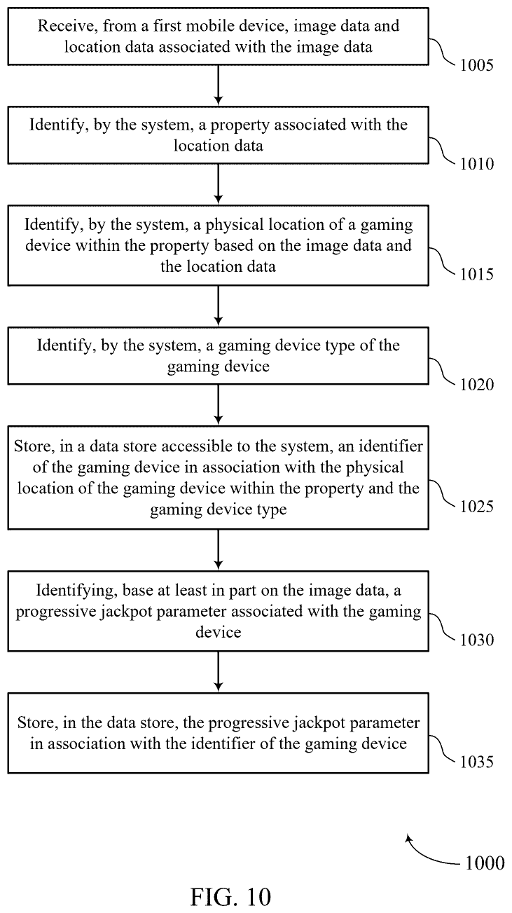

FIG. 10 shows a flowchart illustrating a method 1000 that supports systems for gaming localization and mapping in accordance with aspects of the present disclosure. The operations of the method 1000 may be implemented by a SLAM system or its components as described herein. For example, the operations of the method 1000 may be performed by a SLAM system as described with reference to FIGS. 1 through 8. In some examples, a SLAM system may execute a set of instructions to control the functional elements of the SLAM system to perform the described functions. Additionally, or alternatively, the SLAM system may perform aspects of the described functions using special-purpose hardware.

At 1005, the method may include receiving, from a first mobile device, image data and location data associated with the image data. The operations of 1005 may be performed in accordance with examples as disclosed herein. In some examples, aspects of the operations of 1005 may be performed by an image data collection component 725 as described with reference to FIG. 7.

At 1010, the method may include identifying, by the system, a property associated with the location data. The operations of 1010 may be performed in accordance with examples as disclosed herein. In some examples, aspects of the operations of 1010 may be performed by a gaming property component 730 as described with reference to FIG. 7.

At 1015, the method may include identifying, by the system, a physical location of a gaming device within the property based on the image data and the location data. The operations of 1015 may be performed in accordance with examples as disclosed herein. In some examples, aspects of the operations of 1015 may be performed by a gaming device location component 735 as described with reference to FIG. 7.

At 1020, the method may include identifying, by the system, a gaming device type of the gaming device. The operations of 1020 may be performed in accordance with examples as disclosed herein. In some examples, aspects of the operations of 1020 may be performed by a gaming device type component 740 as described with reference to FIG. 7.

At 1025, the method may include storing, in a data store accessible to the system, an identifier of the gaming device in association with the physical location of the gaming device within the property and the gaming device type. The operations of 1025 may be performed in accordance with examples as disclosed herein. In some examples, aspects of the operations of 1025 may be performed by a gaming device location component 735 as described with reference to FIG. 7.

At 1030, the method may include identifying, based on the image data, a progressive jackpot parameter associated with the gaming device. The operations of 1030 may be performed in accordance with examples as disclosed herein. In some examples, aspects of the operations of 1030 may be performed by a progressive jackpot component 755 as described with reference to FIG. 7.

At 1035, the method may include storing, in the data store, the progressive jackpot parameter in association with the identifier of the gaming device. The operations of 1035 may be performed in accordance with examples as disclosed herein. In some examples, aspects of the operations of 1035 may be performed by a progressive jackpot component 755 as described with reference to FIG. 7.

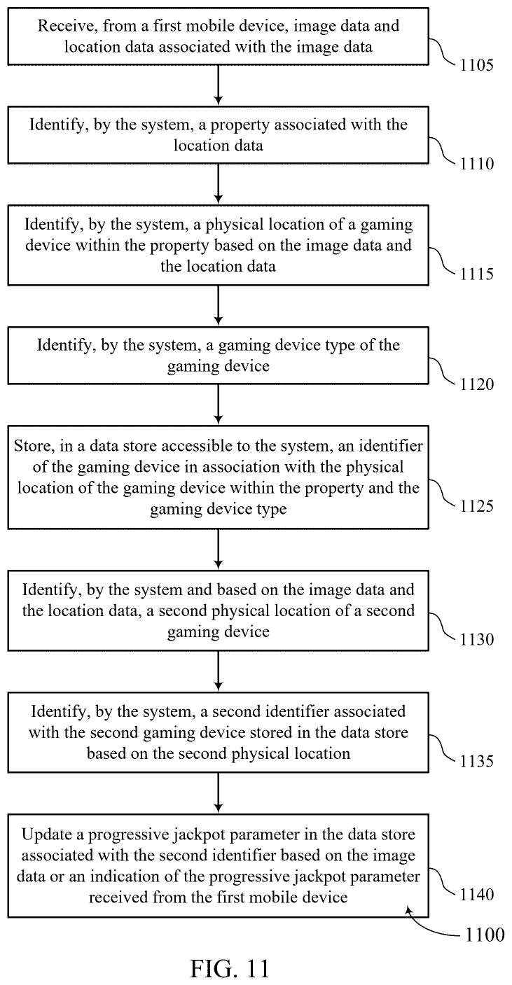

FIG. 11 shows a flowchart illustrating a method 1100 that supports systems for gaming localization and mapping in accordance with aspects of the present disclosure. The operations of the method 1100 may be implemented by a SLAM system or its components as described herein. For example, the operations of the method 1100 may be performed by a SLAM system as described with reference to FIGS. 1 through 8. In some examples, a SLAM system may execute a set of instructions to control the functional elements of the SLAM system to perform the described functions. Additionally, or alternatively, the SLAM system may perform aspects of the described functions using special-purpose hardware.

At 1105, the method may include receiving, from a first mobile device, image data and location data associated with the image data. The operations of 1105 may be performed in accordance with examples as disclosed herein. In some examples, aspects of the operations of 1105 may be performed by an image data collection component 725 as described with reference to FIG. 7.

At 1110, the method may include identifying, by the system, a property associated with the location data. The operations of 1110 may be performed in accordance with examples as disclosed herein. In some examples, aspects of the operations of 1110 may be performed by a gaming property component 730 as described with reference to FIG. 7.

At 1115, the method may include identifying, by the system, a physical location of a gaming device within the property based on the image data and the location data. The operations of 1115 may be performed in accordance with examples as disclosed herein. In some examples, aspects of the operations of 1115 may be performed by a gaming device location component 735 as described with reference to FIG. 7.

At 1120, the method may include identifying, by the system, a gaming device type of the gaming device. The operations of 1120 may be performed in accordance with examples as disclosed herein. In some examples, aspects of the operations of 1120 may be performed by a gaming device type component 740 as described with reference to FIG. 7.

At 1125, the method may include storing, in a data store accessible to the system, an identifier of the gaming device in association with the physical location of the gaming device within the property and the gaming device type. The operations of 1125 may be performed in accordance with examples as disclosed herein. In some examples, aspects of the operations of 1125 may be performed by a gaming device location component 735 as described with reference to FIG. 7.

At 1130, the method may include identifying, by the system and based on the image data and the location data, a second physical location of a second gaming device. The operations of 1130 may be performed in accordance with examples as disclosed herein. In some examples, aspects of the operations of 1130 may be performed by a gaming device location component 735 as described with reference to FIG. 7.

At 1135, the method may include identifying, by the system, a second identifier associated with the second gaming device stored in the data store based on the second physical location. The operations of 1135 may be performed in accordance with examples as disclosed herein. In some examples, aspects of the operations of 1135 may be performed by a gaming device location component 735 as described with reference to FIG. 7.

At 1140, the method may include updating a progressive jackpot parameter in the data store associated with the second identifier based on the image data or an indication of the progressive jackpot parameter received from the first mobile device. The operations of 1140 may be performed in accordance with examples as disclosed herein. In some examples, aspects of the operations of 1140 may be performed by a progressive jackpot component 755 as described with reference to FIG. 7.

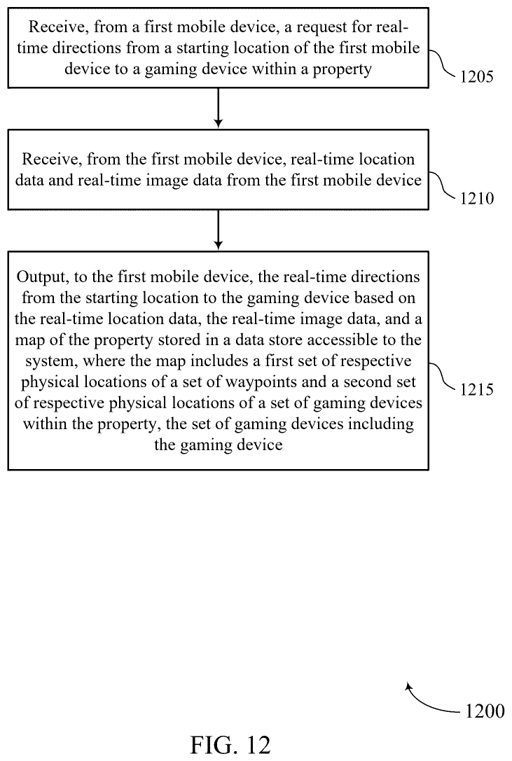

FIG. 12 shows a flowchart illustrating a method 1200 that supports systems for gaming localization and mapping in accordance with aspects of the present disclosure. The operations of the method 1200 may be implemented by a SLAM system or its components as described herein. For example, the operations of the method 1200 may be performed by a SLAM system as described with reference to FIGS. 1 through 8. In some examples, a SLAM system may execute a set of instructions to control the functional elements of the SLAM system to perform the described functions. Additionally, or alternatively, the SLAM system may perform aspects of the described functions using special-purpose hardware.

At 1205, the method may include receiving, from a first mobile device, a request for real-time directions from a starting location of the first mobile device to a gaming device within a property. The operations of 1205 may be performed in accordance with examples as disclosed herein. In some examples, aspects of the operations of 1205 may be performed by a navigation component 745 as described with reference to FIG. 7.

At 1210, the method may include receiving, from the first mobile device, real-time location data and real-time image data from the first mobile device. The operations of 1210 may be performed in accordance with examples as disclosed herein. In some examples, aspects of the operations of 1210 may be performed by a mobile device location component 750 as described with reference to FIG. 7.

At 1215, the method may include outputting, to the first mobile device, the real-time directions from the starting location to the gaming device based on the real-time location data, the real-time image data, and a map of the property stored in a data store accessible to the system, where the map includes a first set of respective physical locations of a set of waypoints and a second set of respective physical locations of a set of gaming devices within the property, the set of gaming devices including the gaming device. The operations of 1215 may be performed in accordance with examples as disclosed herein. In some examples, aspects of the operations of 1215 may be performed by a navigation component 745 as described with reference to FIG. 7.

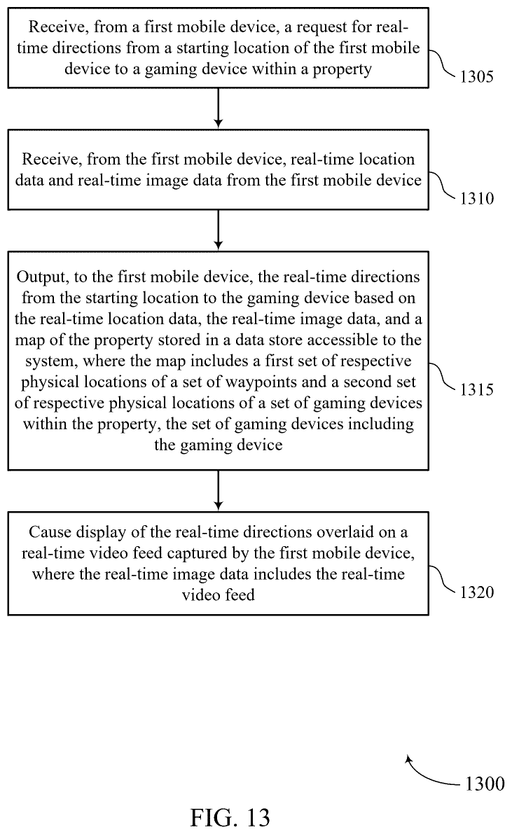

FIG. 13 shows a flowchart illustrating a method 1300 that supports systems for gaming localization and mapping in accordance with aspects of the present disclosure. The operations of the method 1300 may be implemented by a SLAM system or its components as described herein. For example, the operations of the method 1300 may be performed by a SLAM system as described with reference to FIGS. 1 through 8. In some examples, a SLAM system may execute a set of instructions to control the functional elements of the SLAM system to perform the described functions. Additionally, or alternatively, the SLAM system may perform aspects of the described functions using special-purpose hardware.

At 1305, the method may include receiving, from a first mobile device, a request for real-time directions from a starting location of the first mobile device to a gaming device within a property. The operations of 1305 may be performed in accordance with examples as disclosed herein. In some examples, aspects of the operations of 1305 may be performed by a navigation component 745 as described with reference to FIG. 7.

At 1310, the method may include receiving, from the first mobile device, real-time location data and real-time image data from the first mobile device. The operations of 1310 may be performed in accordance with examples as disclosed herein. In some examples, aspects of the operations of 1310 may be performed by a mobile device location component 750 as described with reference to FIG. 7.

At 1315, the method may include outputting, to the first mobile device, the real-time directions from the starting location to the gaming device based on the real-time location data, the real-time image data, and a map of the property stored in a data store accessible to the system, where the map includes a first set of respective physical locations of a set of waypoints and a second set of respective physical locations of a set of gaming devices within the property, the set of gaming devices including the gaming device. The operations of 1315 may be performed in accordance with examples as disclosed herein. In some examples, aspects of the operations of 1315 may be performed by a navigation component 745 as described with reference to FIG. 7.

At 1320, the method may include causing display of the real-time directions overlaid on a real-time video feed captured by the first mobile device, where the real-time image data includes the real-time video feed. The operations of 1320 may be performed in accordance with examples as disclosed herein. In some examples, aspects of the operations of 1320 may be performed by an AR component 765 as described with reference to FIG. 7.

The following provides an overview of aspects of the present disclosure:

Aspect 1: A method at a system, comprising: receiving, from a first mobile device, image data and location data associated with the image data; identifying, by the system, a property associated with the location data; identifying, by the system, a physical location of a gaming device within the property based at least in part on the image data and the location data; identifying, by the system, a gaming device type of the gaming device; and storing, in a data store accessible to the system, an identifier of the gaming device in association with the physical location of the gaming device within the property and the gaming device type.

Aspect 2: The method of aspect 1, further comprising: identifying, based at least in part on the image data, a progressive jackpot parameter associated with the gaming device; and storing, in the data store, the progressive jackpot parameter in association with the identifier of the gaming device.

Aspect 3: The method of any of aspects 1 through 2, further comprising: receiving, from the first mobile device, an indication of a progressive jackpot parameter associated with the gaming device; and storing, in the data store, the progressive jackpot parameter in association with the identifier of the gaming device.

Aspect 4: The method of any of aspects 1 through 3, further comprising: identifying, by the system and based at least in part on the image data and the location data, a second physical location of a second gaming device; identifying, by the system, a second identifier associated with the second gaming device stored in the data store based at least in part on the second physical location; and updating a progressive jackpot parameter in the data store associated with the second identifier based at least in part on the image data or an indication of the progressive jackpot parameter received from the first mobile device.

Aspect 5: The method of any of aspects 1 through 4, further comprising: identifying, based at least in part on the image data and the location data, one or more waypoints within the property; and storing, in the data store, one or more respective identifiers for the one or more waypoints in association with one or more respective identified physical locations of the one or more waypoints.

Aspect 6: The method of aspect 5, wherein the one or more waypoints comprise an entrance to the property, a restroom, a restaurant, a retail store, a physical sign, an automatic teller machine, an elevator bank, a stairway, a bar, a ticket window, or a combination thereof.

Aspect 7: The method of any of aspects 5 through 6, further comprising: creating a map of the property based at least in part on the one or more respective identified physical locations of the one or more waypoints and the physical location of the gaming device.

Aspect 8: The method of aspect 7, further comprising: receiving, from a second mobile device, a request for directions to the gaming device; and outputting real-time directions to the gaming device to the second mobile device based at least in part on the map of the property and second location data of the second mobile device.

Aspect 9: The method of any of aspects 5 through 8, further comprising: updating a map of the property based at least in part on the identified one or more waypoints and the identified gaming device; and outputting, to the first mobile device in parallel with updating the map, real-time directions to a second gaming device in the property based at least in part on the map and the location data of the first mobile device.

Aspect 10: The method of aspect 9, further comprising: receiving real-time motion data from the first mobile device to determine a real-time location of the first mobile device within the map in accordance with a simultaneous location and mapping scheme, wherein the real-time directions are based at least in part on the real-time location.

Aspect 11: The method of aspect 10, wherein the real-time motion data comprises accelerometer data, gyroscope data, or magnetometer data.

Aspect 12: The method of any of aspects 1 through 11, further comprising: identifying, by the system, a second physical location of a second gaming device within the property based at least in part on the image data and the location data; identifying, by the system, a second gaming device type of the second gaming device; and storing, in the data store, a second identifier of the second gaming device in association with the second physical location of the gaming device within the property and in association with the second gaming device type.

Aspect 13: The method of any of aspects 1 through 12, further comprising: identifying, by the system, a second physical location of a second gaming device within the property based at least in part on the image data and the location data; identifying, by the system, that the second gaming device is the gaming device type; and storing, in the data store, a second identifier of the second gaming device in association with the second physical location of the gaming device within the property and in association with the gaming device type.

Aspect 14: The method of any of aspects 1 through 13, further comprising: receiving, from the first mobile device or a second mobile device, second image data and second location data associated with the second image data; identifying, by the system, a second property associated with the second location data; identifying, by the system, a second physical location of a second gaming device within the second property based at least in part on the second image data and the second location data; identifying, by the system, a second gaming device type of the second gaming device; and storing, in the data store, a second identifier of the second gaming device in association with the second physical location of the second gaming device within the second property and in association with the second gaming device type.

Aspect 15: The method of any of aspects 1 through 14, further comprising: receiving, from the first mobile device or a second mobile device, second image data and second location data associated with the second image data; identifying, by the system, a second property associated with the second location data; identifying, by the system, a second physical location of a second gaming device within the second property based at least in part on the second image data and the second location data; identifying, by the system, that the second gaming device has the gaming device type; and storing, in the data store, a second identifier of the second gaming device in association with the second physical location of the second gaming device within the second property and in association with the gaming device type.

Aspect 16: The method of any of aspects 1 through 15, wherein identifying the physical location of the gaming device comprises: identifying the physical location of the gaming device with respect to a second physical location of the first mobile device at a time the image data is captured, wherein the location data corresponds to the second physical location of the first mobile device at the time the image data is captured.

Aspect 17: The method of any of aspects 1 through 16, wherein receiving the location data comprises: receiving the location data based at least in part on a Wi-Fi connection or a Bluetooth connection of the first mobile device within the property.

Aspect 18: The method of any of aspects 1 through 17, wherein identifying the gaming device type comprises: comparing an image of the gaming device from the image data to a set of images corresponding to a set of gaming device types, wherein the set of gaming device types include the gaming device type, and wherein the gaming device is identified as having the gaming device type based at least in part on the image of the gaming device satisfying a similarity threshold with a respective image of the gaming device type.

Aspect 19: The method of any of aspects 1 through 18, wherein identifying the gaming device type comprises: receiving, from the first mobile device, an indication of the gaming device type.

Aspect 20: The method of aspect 19, further comprising: outputting a gaming device type input window to the first mobile device based at least in part on identifying the gaming device within the image data, wherein receiving the indication of the gaming device comprises receiving an input of the gaming device type via the gaming device type input window.

Aspect 21: The method of any of aspects 1 through 20, wherein identifying the property comprises: comparing the location data to a set of stored locations of a set of properties; and identifying the property based at least in part on the location data matching a stored location of the set of properties.

Aspect 22: A method at a system, comprising: receiving, from a first mobile device, a request for real-time directions from a starting location of the first mobile device to a gaming device within a property; receiving, from the first mobile device, real-time location data and real-time image data from the first mobile device; and outputting, to the first mobile device, the real-time directions from the starting location to the gaming device based at least in part on the real-time location data, the real-time image data, and a map of the property stored in a data store accessible to the system, wherein the map comprises a first set of respective physical locations of a set of waypoints and a second set of respective physical locations of a set of gaming devices within the property, the set of gaming devices comprising the gaming device.

Aspect 23: The method of aspect 22, wherein causing presentation of the real-time directions comprises: causing display of the real-time directions overlaid on a real-time video feed captured by the first mobile device, wherein the real-time image data comprises the real-time video feed.

Aspect 24: The method of aspect 23, wherein the real-time directions comprise one or more augmented objects overlaid on the real-time video feed.

Aspect 25: The method of any of aspects 22 through 24, wherein causing presentation of the real-time directions is based at least in part on identifying at least one way point of the set of waypoints or at least one gaming device of the set of gaming devices.

Aspect 26: The method of any of aspects 22 through 25, further comprising: identifying, based at least in part on the real-time image data, a progressive jackpot parameter of a second gaming device of the set of gaming devices; and updating the progressive jackpot parameter associated with an identifier for the second gaming device in the data store based at least in part on identifying the progressive jackpot parameter.

Aspect 27: The method of any of aspects 22 through 26, further comprising: receiving real-time motion data from the first mobile device to determine a real-time location of the first mobile device within the map in accordance with a simultaneous location and mapping scheme, wherein the real-time directions are based at least in part on the real-time location.

Aspect 28: The method of aspect 27, wherein the real-time motion data comprises accelerometer data, gyroscope data, or magnetometer data.

Aspect 29: The method of any of aspects 22 through 28, wherein the real-time location data is based at least in part on a Wi-Fi connection or a Bluetooth connection of the first mobile device within the property.

Aspect 30: The method of any of aspects 22 through 29, further comprising: receiving, from the first mobile device, a second request for a listing of gaming devices of a gaming device type; outputting, to the first mobile device and based at least in part on the second request, the listing of gaming devices and respective locations of gaming devices of the listing of gaming devices, the listing of gaming devices including the gaming device; and receiving, from the first mobile device, a selection of the gaming device, wherein receiving the request for the real-time directions is based at least in part on receiving the selection.

Aspect 31: The method of aspect 30, wherein causing presentation of the respective locations of the gaming devices comprises causing presentation of respective properties at which each of the gaming devices are located.

Aspect 32: The method of any of aspects 30 through 31, further comprising: outputting, to the first mobile device, respective progressive jackpot parameters associated with each of the gaming devices.

Aspect 33: The method of any of aspects 22 through 32, further comprising: receiving, from the first mobile device, a second request for a listing of gaming devices that satisfy a progressive jackpot parameter threshold; outputting, to the first mobile device and based at least in part on the second request, the listing of gaming devices and respective locations of gaming devices of the listing of gaming devices, the listing of gaming devices including the gaming device; and receiving, from the first mobile device, a selection of the gaming device, wherein receiving the request for the real-time directions is based at least in part on receiving the selection.

Aspect 34: The method of any of aspects 22 through 33, further comprising: outputting, to the first mobile device and based at least in part on the real-time location data, an advertisement associated with the property.

Aspect 35: The method of any of aspects 22 through 34, wherein the set of waypoints comprise an entrance to the property, a restroom, a restaurant, a retail store, a physical sign, an automatic teller machine, an elevator bank, a stairway, a bar, a ticket window, or a combination thereof.

Aspect 36: The method of any of aspects 22 through 35, further comprising: causing output, by the first mobile device, of audio cues in association with the outputting of the real-time directions.

Aspect 37: A system comprising one or more memories storing processor-executable code, and one or more processors coupled with the one or more memories and individually or collectively operable to execute the code to cause the system to perform a method of any of aspects 1 through 21.

Aspect 38: A system comprising at least one means for performing a method of any of aspects 1 through 21.

Aspect 39: A non-transitory computer-readable medium storing code the code comprising instructions executable by one or more processors to perform a method of any of aspects 1 through 21.

Aspect 40: A system comprising one or more memories storing processor-executable code, and one or more processors coupled with the one or more memories and individually or collectively operable to execute the code to cause the system to perform a method of any of aspects 22 through 36.

Aspect 41: A system comprising at least one means for performing a method of any of aspects 22 through 36.

Aspect 42: A non-transitory computer-readable medium storing code the code comprising instructions executable by one or more processors to perform a method of any of aspects 22 through 36.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.” Also, as used herein, the phrase “a set” shall be construed as including the possibility of a set with one member. That is, the phrase “a set” shall be construed in the same manner as “one or more.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method at a system, comprising:
receiving, from a first mobile device, image data and location data associated with the image data;
identifying, by the system, a property associated with the location data;
identifying, by the system, a physical location of a gaming device within the property based at least in part on the image data and the location data;
identifying, by the system, a gaming device type of the gaming device; and
storing, in a data store accessible to the system, an identifier of the gaming device in association with the physical location of the gaming device within the property and the gaming device type.

2. The method of claim 1, further comprising:
identifying, based at least in part on the image data, a progressive jackpot parameter associated with the gaming device; and
storing, in the data store, the progressive jackpot parameter in association with the identifier of the gaming device.

3. The method of claim 1, further comprising:
receiving, from the first mobile device, an indication of a progressive jackpot parameter associated with the gaming device; and
storing, in the data store, the progressive jackpot parameter in association with the identifier of the gaming device.

4. The method of claim 1, further comprising:
identifying, by the system and based at least in part on the image data and the location data, a second physical location of a second gaming device;
identifying, by the system, a second identifier associated with the second gaming device stored in the data store based at least in part on the second physical location; and
updating a progressive jackpot parameter in the data store associated with the second identifier based at least in part on the image data or an indication of the progressive jackpot parameter received from the first mobile device.

5. The method of claim 1, further comprising:
identifying, based at least in part on the image data and the location data, one or more waypoints within the property; and
storing, in the data store, one or more respective identifiers for the one or more waypoints in association with one or more respective identified physical locations of the one or more waypoints, wherein the one or more waypoints comprise an entrance to the property, a restroom, a restaurant, a retail store, a physical sign, an automatic teller machine, an elevator bank, a stairway, a bar, a ticket window, or a combination thereof.

6. The method of claim 5, further comprising:
creating a map of the property based at least in part on the one or more respective identified physical locations of the one or more waypoints and the physical location of the gaming device;
receiving, from a second mobile device, a request for directions to the gaming device; and
outputting real-time directions to the gaming device to the second mobile device based at least in part on the map of the property and second location data of the second mobile device.

7. The method of claim 5, further comprising:
updating a map of the property based at least in part on the identified one or more waypoints and the identified gaming device;
receiving real-time motion data from the first mobile device to determine a real-time location of the first mobile device within the map in accordance with a simultaneous location and mapping scheme; and
outputting, to the first mobile device in parallel with updating the map, real-time directions to a second gaming device in the property based at least in part on the map and the real-time location, wherein the real-time motion data comprises accelerometer data, gyroscope data, or magnetometer data.

8. The method of claim 1, further comprising:
identifying, by the system, a second physical location of a second gaming device within the property based at least in part on the image data and the location data;
identifying, by the system, a second gaming device type of the second gaming device; and
storing, in the data store, a second identifier of the second gaming device in association with the second physical location of the gaming device within the property and in association with the second gaming device type.

9. The method of claim 1, further comprising:
identifying, by the system, a second physical location of a second gaming device within the property based at least in part on the image data and the location data;
identifying, by the system, that the second gaming device is the gaming device type; and
storing, in the data store, a second identifier of the second gaming device in association with the second physical location of the gaming device within the property and in association with the gaming device type.

10. The method of claim 1, further comprising:
receiving, from the first mobile device or a second mobile device, second image data and second location data associated with the second image data;
identifying, by the system, a second property associated with the second location data;
identifying, by the system, a second physical location of a second gaming device within the second property based at least in part on the second image data and the second location data;
identifying, by the system, a second gaming device type of the second gaming device; and
storing, in the data store, a second identifier of the second gaming device in association with the second physical location of the second gaming device within the second property and in association with the second gaming device type.

11. The method of claim 1, further comprising:
receiving, from the first mobile device or a second mobile device, second image data and second location data associated with the second image data;
identifying, by the system, a second property associated with the second location data;
identifying, by the system, a second physical location of a second gaming device within the second property based at least in part on the second image data and the second location data;
identifying, by the system, that the second gaming device has the gaming device type; and
storing, in the data store, a second identifier of the second gaming device in association with the second physical location of the second gaming device within the second property and in association with the gaming device type.

12. The method of claim 1, wherein:
identifying the gaming device type comprises receiving, from the first mobile device, an indication of the gaming device type; and
the method further comprises outputting a gaming device type input window to the first mobile device based at least in part on identifying the gaming device within the image data, wherein receiving the indication of the gaming device comprises receiving an input of the gaming device type via the gaming device type input window.

13. A method at a system, comprising:
receiving, from a first mobile device, a request for real-time directions from a starting location of the first mobile device to a gaming device within a property;
receiving, from the first mobile device, real-time location data and real-time image data from the first mobile device; and
outputting, to the first mobile device, the real-time directions from the starting location to the gaming device based at least in part on the real-time location data, the real-time image data, and a map of the property stored in a data store accessible to the system, wherein the map comprises a first set of respective physical locations of a set of waypoints and a second set of respective physical locations of a set of gaming devices within the property, the set of gaming devices comprising the gaming device.

14. The method of claim 13, wherein causing presentation of the real-time directions comprises:
causing display of the real-time directions overlaid on a real-time video feed captured by the first mobile device, wherein the real-time image data comprises the real-time video feed, wherein the real-time directions comprise one or more augmented objects overlaid on the real-time video feed.

15. The method of claim 13, wherein causing presentation of the real-time directions is based at least in part on identifying at least one way point of the set of waypoints or at least one gaming device of the set of gaming devices.

16. The method of claim 13, further comprising:
identifying, based at least in part on the real-time image data, a progressive jackpot parameter of a second gaming device of the set of gaming devices; and
updating the progressive jackpot parameter associated with an identifier for the second gaming device in the data store based at least in part on identifying the progressive jackpot parameter.

17. The method of claim 13, further comprising:
receiving real-time motion data from the first mobile device to determine a real-time location of the first mobile device within the map in accordance with a simultaneous location and mapping scheme, wherein the real-time directions are based at least in part on the real-time location, wherein the real-time motion data comprises accelerometer data, gyroscope data, or magnetometer data.

18. The method of claim 13, further comprising:
receiving, from the first mobile device, a second request for a listing of gaming devices of a gaming device type;
outputting, to the first mobile device and based at least in part on the second request, the listing of gaming devices and respective locations of gaming devices of the listing of gaming devices and respective progressive jackpot parameters associated with each of the gaming devices, the listing of gaming devices including the gaming device; and
receiving, from the first mobile device, a selection of the gaming device, wherein receiving the request for the real-time directions is based at least in part on receiving the selection.

19. The method of claim 13, further comprising:
receiving, from the first mobile device, a second request for a listing of gaming devices that satisfy a progressive jackpot parameter threshold;
outputting, to the first mobile device and based at least in part on the second request, the listing of gaming devices and respective locations of gaming devices of the listing of gaming devices, the listing of gaming devices including the gaming device; and
receiving, from the first mobile device, a selection of the gaming device, wherein receiving the request for the real-time directions is based at least in part on receiving the selection.

20. The method of claim 13, further comprising:
causing output, by the first mobile device, of audio cues in association with the outputting of the real-time directions.
